(19) United States
(12) Patent Application Publication
(10) Pub. No.: US 2007/0272285 A1
(43) Pub. Date: Nov. 29, 2007

(54) Appliance noise reduction blanket

(76) Inventors: Kevin M. Herreman, Newark, OH (US); Jacob T. Chacko, Pickerington, OH (US); Anthony L. Rockwell, Pickerington, OH (US); Thomas P. McGuire, Laurelville, OH (US); Christopher C. Freidner, Heath, OH (US)

Correspondence Address: OWENS CORNING, 2790 COLUMBUS ROAD, GRANVILLE, OH, 43023, US

(21) Appl. No.: 11/711,380

(22) Filed: Feb. 27, 2007

Related U.S. Application Data
(60) Provisional application No. 60/777,199, filed on Feb. 27, 2006.

(51) Int. Cl. B08B 3/00

(52) U.S. Cl. 134/58 D

(57) ABSTRACT

A dishwasher includes a housing having a washing chamber and an access door, a plurality of legs supporting the housing, a pump and a drive motor provided in a cavity between the legs and below the housing, a plate closing a front side of the cavity, an insulator provided between the plate and the pump and drive motor and a first side shield closing a first side of the cavity.

### TECHNICAL FIELD AND INDUSTRIAL APPLICABILITY OF THE INVENTION

This invention relates generally to kitchen appliance technology and, more particularly, to an acoustic treatment and related method for insulating an under-counter kitchen appliance.

### BACKGROUND OF THE INVENTION

Automatic dishwashers have long been known as a particularly convenient and efficient way to clean dishes following their use. Such dishwashers generally include a washing chamber for holding the dishes and one or more streams of pressurized fluid for washing food and drink residue from the dishes. Unfortunately, the washing process generates considerable noise, which can be quite annoying to the user. In an effort to reduce this noise, it has long been known to provide dishwashers with acoustical insulation.

Conventional acoustical insulation systems for dishwashers generally comprise sound transmission barriers and sound absorption layers. Typically, acoustical insulation involves enclosing the noise source in an insulation structure. A typical form of acoustical insulation is a layer of polymer fiber insulation, such as polyester fiber insulation, wrapped around or positioned around the source of the unwanted noise. For example, a polyester blanket is usually wrapped around the sides, top and rear while separate polyester/fiberglass absorbers are usually incorporated into the front door and access panels of an under the counter dishwasher. Together, the blanket and absorbers function to reduce the transmission of unwanted sound from the source of the sound in the dishwasher to the kitchen environment.

The present invention relates to an advanced system or treatment for insulating a kitchen appliance such as a dishwasher.

### SUMMARY OF THE INVENTION

To achieve the foregoing and other objects and in accordance with the purposes of present invention as described herein, a dishwasher is provided comprising a housing including a washing chamber and an access door, a plurality of legs supporting the housing, a pump and a drive motor provided in a cavity between the legs and below the housing, a plate closing a front side of the cavity, an insulator provided between the plate and the pump and drive motor and a first side shield closing a first side of the cavity. Still further, the dishwasher may include a second side shield closing a second side of the cavity and even a third shield closing a third side of the cavity.

More specifically describing the invention, the insulator includes a first layer of fibrous insulating material and a layer of barrier material. The first layer of fibrous insulating material has an airflow resistivity of between about 3,000 to about 18,000 mks rayls/m and the barrier layer has a weight per unit area of between about 0.5 to about 2.5 pounds per square foot. The first layer of fibrous insulating material is selected from a group consisting of glass fibers, polyolefin fibers, polyester fibers, polypropylene fibers, polyethylene fibers, polyethylene terephthalate fibers, polybutylene terephthalate fibers, cotton fibers, hemp fibers, jute fibers, kenaf fibers, rayon fibers, nylon fibers, acrylic fibers, copolyester fibers and mixtures thereof. If chopped fibers are used, they are chopped to a length of between about 0.635 to about 7.62 cm and have a diameter of between about 2.0 and about 60.0 microns. The first layer of fibrous insulating material may take the form of a nonwoven mat or a nonwoven veil. Further the first layer of fibrous insulating material may comprise by weight percent between about 10 to about 70% glass fibers and between about 90 to about 30% polymer fibers. The polymer fibers may include staple fibers, binder fibers or mixtures thereof.

In one possible embodiment the first layer of fibrous insulating material comprises 100% polyester fibers having a length of between about 1.2 to about 15.2 cm and a diameter of between about 5.0 to about 60.0 microns. The first layer of fibrous insulating material also has a density of between about 0.5 to about 4.0 pounds per cubic foot.

The barrier material is selected from a group consisting of ethylene vinyl acetate, barium filled rubber, asphalt and mixtures thereof. Where the plate has a width A, the barrier layer has a width B where B>A.

Still further describing the invention, the first, second and third side shields may be made from an insulating material selected from a group consisting of glass fibers, polyolefin fibers, polyester fibers, polypropylene fibers, polyethylene fibers, polyethylene terephthalate fibers, polybutylene terephthalate fibers, cotton fibers, hemp fibers, jute fibers, kenaf fibers, rayon fibers, nylon fibers, acrylic fibers, copolyester fibers and mixtures thereof and (b) have an airflow resistivity of between about 3,000 to about 18,000 mks rayls/m.

In addition, the dishwasher may include an insulation blanket covering a top wall, a rear wall, a first side wall and a second side wall of the housing. That insulation blanket may be constructed from a material selected from a group consisting of polyester, polyolefin, polyethylene, rayon, nylon, acrylic, hemp, kenaf, cotton, fiberglass and combinations thereof. Still further, the dishwasher may also include an insulating element provided in the access door of the housing. Additionally, at least one shield of the first, second and third side shields may include a barrier layer.

In the following description there is shown and described several embodiments of this invention simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of this specification, illustrate several aspects of the present invention, and together with the description serve to explain certain principles of the invention. In the drawings:

FIG. 1 is a perspective and partially cross-sectional view of the dishwasher of the present invention incorporating a new, advanced insulating system;

FIG. 2 is a top plan view of an acoustical blanket used to cover the top, rear and side walls of the dishwasher;

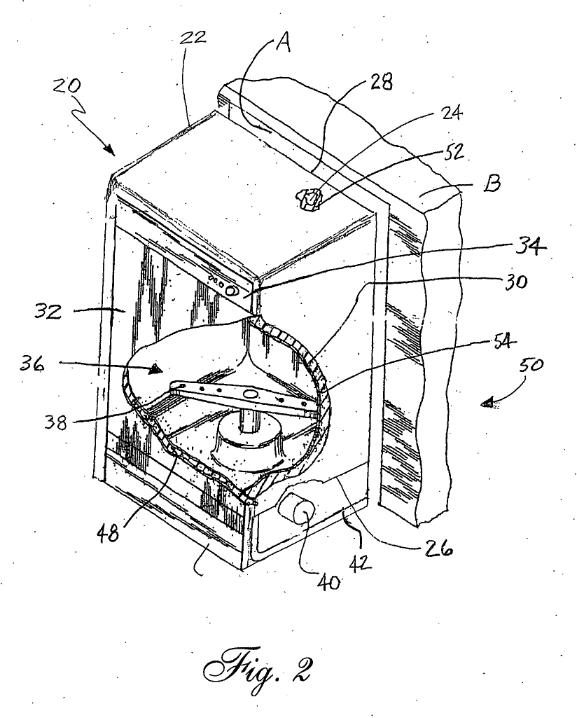

FIG. 3 is a perspective view of a face plate insulator;

FIG. 4 is a side elevational view showing the dishwasher of FIG. 1 including the acoustical blanket of FIG. 2 (note, near side leg is removed for clarity of illustration) and the insulator of FIG. 3; and

FIG. 5 is a schematical bottom plan view showing how the insulating system encloses the pump and drive motor in the cavity of the dishwasher between the legs and under the dishwasher housing.

### DETAILED DESCRIPTION AND PREFERRED EMBODIMENTS OF THE INVENTION

Reference is now made to the drawing figures illustrating the dishwasher 10 of the present invention that incorporates a unique insulating system including the insulator 12, first side shield 14, second side shield 16, third or rear shield 18 and insulating blanket 20.

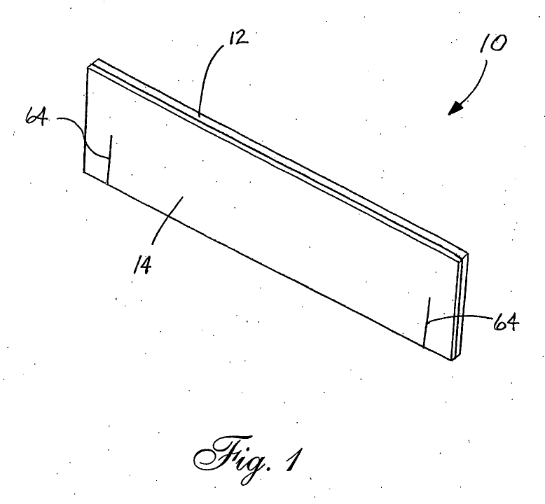

As illustrated in FIG. 1, the dishwasher 10 includes a housing 22 having a top wall 24, bottom wall 26, rear wall 28, two opposing side walls 30 and a front access door 32. The dishwasher 10 also incorporates a front control panel 34 above the access door 32. The housing 22 defines an internal washing chamber 36 accessed through the door 32. A washing nozzle 38 in the washing chamber 36 directs a fluid stream against dishes held in the washing chamber. A circulation pump and drive motor 40 circulates that fluid under pressure through the washing nozzle 38.

As should be further appreciated from reviewing FIGS. 1, 4 and 5, the housing 22 is supported on a plurality of legs 42. In the illustrated embodiment the dishwasher 20 includes two unitary front and rear legs 42 and each leg carries two height adjustable feet 44. As illustrated the pump and drive motor 40 are provided in a cavity formed under the housing 22 and between the legs 42. A removable face or toe kick plate 46 is provided beneath the access door 32 and in front of the legs 42. This toe kick plate 46 may be removed to access the pump and drive motor 40 when the dishwasher 20 is mounted in a cavity A under a counter B as illustrated in FIG. 1.

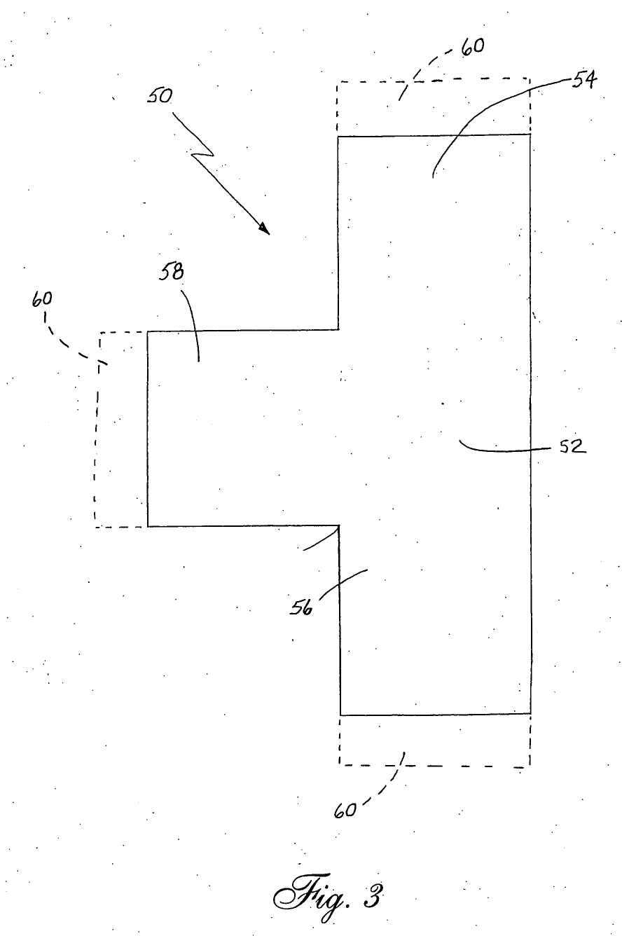

As best illustrated in FIG. 1 the dishwasher 10 includes an insulating element 48 in the access door 32 of the housing 22. Further, the blanket 20 of insulating material is provided over the top wall 24, rear wall 28 and side walls 30 of the housing 22. More specifically, the blanket 20 is best illustrated in FIG. 3. The blanket 20 is positioned over the washer so that the main portion 52 of the blanket covers the top wall 24 of the housing 20. The first, second and third flaps 54, 56, 58 of the blanket 20 are then folded down, respectively, over the left side wall 30, right side wall 30 and rear wall 28 of the housing 22 and the seams may be sealed with tape 59. In one possible embodiment the blanket 20 is made from a material selected from a group consisting of polyester, polyolefin, polyethylene, rayon, nylon, acrylic, hemp, kenaf, cotton, fiberglass and combinations thereof. Together, the insulating element 48 in the access door 32 and the blanket 20 around the walls 24, 28, 30 of the housing 22 function to absorb noise that would otherwise enter the room from the washing chamber 36.

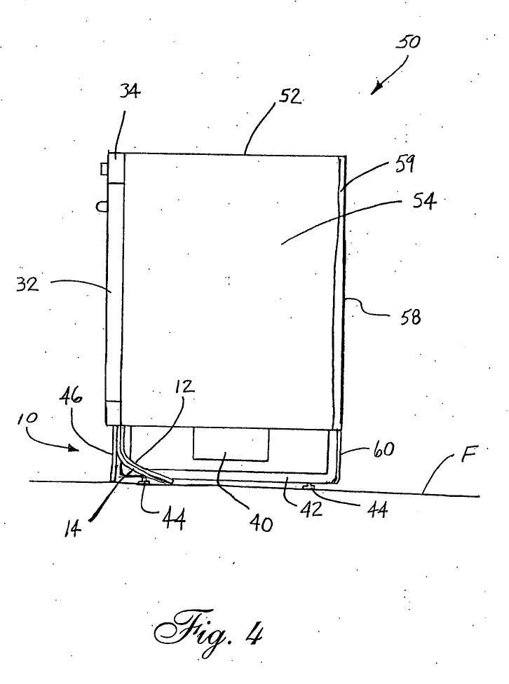

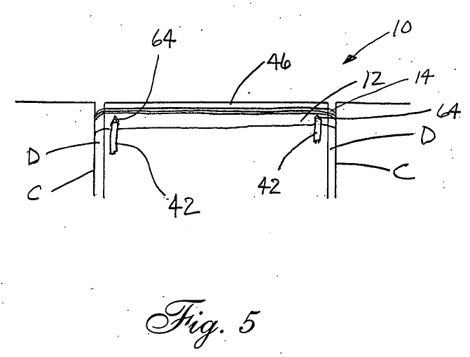

As best illustrated in FIGS. 4 and 5, the insulator 12, the first side shield 14, the second side shield 16 and the rear shield 18 function to absorb noise and reduce noise transmission from the pump and drive motor 40 provided in the cavity under the housing 22. More specifically, the insulator 12 includes a first layer 60 of fibrous insulating material (see FIG. 3). That material typically has an airflow resistivity of between about 3,000 to about 18,000 mks rayls/m. In addition the insulator 12 includes a layer 62 of barrier material. The barrier layer 62 typically has a weight per unit area of about 0.5 to about 2.5 pounds per square foot. The two layers 60, 62 may be secured together by means of adhesive and/or any appropriate type of mechanical fastener such as a staple. The thickness of both layers, when secured, is between about 0.5 to about 4 inches.

The first layer 60 of fibrous insulating material is selected from a group of materials consisting of glass fibers, polyolefin fibers, polyester fibers, polypropylene fibers, polyethylene fibers, polyethylene terephthalate fibers, polybutylene terephthalate fibers, cotton fibers, hemp fibers, jute fibers, kenaf fibers, rayon fibers, nylon fibers, acrylic fibers, copolyester fibers and mixtures thereof. In one possible embodiment the fibers in the layer 60 are continuous and have a diameter of between about 2.0 to about 60.0 microns. In another possible embodiment the fibers in the layer 60 are chopped to a length of between about 0.635 to about 7.62 cm and have a diameter of between about 2.0 and about 60.0 microns.

Typically the first layer 60 of fibrous insulating material is a nonwoven mat or a nonwoven veil. In one particularly useful embodiment the first layer 60 of fibrous insulating material comprises by weight percent between about 10 to about 70% glass fibers and between about 90 to about 30% polymer fibers. Typically those polymer fibers are stable fibers, binder fibers or combinations thereof. In another particularly useful embodiment, the first layer 60 of fibrous insulating material comprises 100% polyester fibers having a length of between about 1.2 to about 15.2 cm and a diameter of between about 5.0 to about 60.0 microns. In any of the embodiments the first layer 60 of fibrous insulating material may have a density of between about 0.5 to about 4.0 pounds per cubic foot. This construction provides desirable acoustic characteristics for absorbing relatively low frequency noise in a range of approximately 100 to 400 Hz as commonly associated with pumps and drive motors 40 of dishwashing equipment.

The material used to make the barrier layer 62 may be selected from a group consisting of ethylene vinyl acetate, barium filled rubber, asphalt and mixtures thereof. The thickness of the barrier layer 62 may be varied to provide the desired transmission barrier and cooperate with the sound absorption characteristics of the first layer 60 to provide the most efficient and effective noise suppression for a particular application.

As best illustrated in FIGS. 4 and 5, the insulator 12 of FIG. 3 is provided between the toe kick plate 46 and the pump and drive motor 40. Optional slits 64 may be provided in the insulator 12 to allow the insulator to receive, accommodate and extend around the legs 42 where necessary for proper mounting. The insulator 12 is positioned with the layer 60 of fibrous insulating material oriented toward the plate 46 and the barrier layer 14 toward the pump and drive motor 40. It should be appreciated that the barrier layer 62 has been carefully chosen to reflect noise at the lower frequencies generally associated with the pump and drive motor 40 of a particular application. Further, the insulating layer 60 has been carefully tuned to absorb noise at those same lower frequencies so that any pump and motor noise transmitted through barrier layer 62 is absorbed and substantially reduced or eliminated. This is done by selecting different materials, fiber diameters and densities to produce a desired air resistivity to provide the best possible sound attenuation. For maximum effectiveness, the insulator 12 must extend across the full width of the plate 46 from the bottom wall 26 of the housing 22 to the floor F.

As further illustrated in FIGS. 4 and 5, the first side shield 14 extends from the bottom of the housing 22 over the legs 42 to the floor F upon which the dishwasher rests thereby closing that first side of the cavity. Similarly, the second side shield 16 extends from the housing 22 down to the floor F closing the second side of the cavity. In the same manner the rear shield 18 extends down from the housing 22 to the floor F closing the third or rear side of the cavity. The first side shield 14 may comprise an extension of the flap 54 of the blanket 20. The second side shield 16 may comprise an extension of the flap 56 of the blanket 20. The rear shield 18 may comprise an extension of the third flap 58 of the blanket 20. Thus, any one, two or all three of the shields 14, 16, 18 may be made from the same material as the blanket. If desired the shields 14, 16, 18 may be slit and the slits separated to receive the legs 42 and hold the shields in position when folded under the housing 22 and resting along the floor F. Alternatively, the shields may be made from a different material that is attached to the blanket 20 or otherwise secured at the bottom margin of the housing 22 around each side and rear opening leading to the cavity.

In a particularly useful embodiment the shields 14, 16, 18 are made from the same material as the first insulating layer 60 of the insulator 12. As a consequence, any pump and motor noise reflected by the barrier layer 62 away from the plate 46 is directed toward the shields 14, 16, 18 that muffle and absorb that noise and prevent the noise from exiting the cavity underneath the housing 22 of the dishwasher 10. Of course, for maximum effectiveness the shields 14, 16, 18 must extend continuously from the bottom wall 26 of the housing 22 to the floor F. Further, the shields 14, 16, 18 and the insulator 12 must also meet at the corners where they may be joined by tape or other means if desired. In this way, the cavity beneath the housing 22 is subjected to an “acoustic seal.”

As should be further appreciated from reviewing FIG. 5, the barrier layer 62 of the insulator 12 has a width B wider than the width A of the face or kick plate 46. In fact, the barrier layer 62 may be wide enough to close the gap between the dishwasher 20 and the side wall S of the cabinet C under which the dishwasher is mounted. This further diminishes the pump and drive motor noise that escapes from the cavity to the environment.

The foregoing description of the preferred embodiments of the invention has been presented for purposes of illustration and description. It is not intended to be exhaustive or to limit the invention to the precise form disclosed. Obvious modifications or variations are possible in light of the above teachings. For example, the blanket 20 or any portion 52, flap 54, 56, 58 may incorporate a barrier layer if desired. Any or all of the shields 14, 16, 18 may also incorporate a barrier layer. Further, while three shields 14, 16, 18 are shown, less than three could be provided. A layer of open cell foam material might also be used as a substitute for fibrous insulating layer 60 so long as the foam material exhibits an air flow resistivity of between about 3,000 to about 18,000 mks rayls/m.

Further, while a two layer insulator 12 has been illustrated and described, the insulator could include three, four or more layers. Possible constructions include but are not limited to a three layer insulator having a layer of barrier material sandwiched between two layers of fibrous insulating material and a four layer insulator including alternating layers of fibrous insulating material and barrier material.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A dishwasher, comprising:
a housing including a washing chamber and an access door;
a plurality of legs supporting said housing;
a pump and a drive motor provided in a cavity between said legs and below said housing;
a plate closing a front side of said cavity;
an insulator provided between said plate and said pump and said drive motor; and
a first side shield closing a first side of said cavity.

2. The dishwasher of claim 1 including a second side shield closing a second side of said cavity.

3. The dishwasher of claim 2, including a third shield closing a third side of said cavity.

4. The dishwasher of claim 3, wherein said insulator includes a first layer of fibrous insulating material and a layer of barrier material.

5. The dishwasher of claim 4, wherein said first layer of fibrous insulating material has an airflow resistivity of between about 3,000 to about 18,000 mks rayls/m and said barrier layer has a weight per unit area of between about 0.5 to about 2.5 pounds per square foot.

6. The dishwasher of claim 5, wherein said first layer of fibrous insulating material is selected from a group consisting of glass fibers, polyolefin fibers, polyester fibers, polypropylene fibers, polyethylene fibers, polyethylene terephthalate fibers, polybutylene terephthalate fibers, cotton fibers, hemp fibers, jute fibers, kenaf fibers, rayon fibers, nylon fibers, acrylic fibers, copolyester fibers and mixtures thereof.

7. The dishwasher of claim 6, wherein said fibers are chopped to a length of between about 0.635 to about 7.62 cm and have a diameter of between about 2.0 and about 60.0 microns.

8. The dishwasher of claim 6, wherein said first layer of fibrous insulating material is a nonwoven mat.

9. The dishwasher of claim 6, wherein said first layer of fibrous insulating material is a nonwoven veil.

10. The dishwasher of claim 4, wherein said first layer of fibrous insulating material comprises by weight percent between about 10 to about 70% glass fibers and between about 90 to about 30% polymer fibers.

11. The dishwasher of claim 10, wherein said polymer fibers include staple fibers, binder fibers or mixtures thereof.

12. The dishwasher of claim 4, wherein said first layer of fibrous insulating material comprises 100% polyester fibers having a length of between about 1.2 to about 15.2 cm and a diameter of between about 5.0 to about 60.0 microns.

13. The dishwasher of claim 4, wherein said first layer of fibrous insulating material has a density of between about 0.5 to about 4.0 pounds per cubic foot.

14. The dishwasher of claim 4, wherein said barrier material is selected from a group consisting of ethylene vinyl acetate, barium filled rubber, asphalt and mixtures thereof.

15. The dishwasher of claim 4, wherein said plate has a width A and said barrier layer has a width B where B>A.

16. The dishwasher of claim 4, wherein said first side shield, said second side shield and said third side shield (a) are made from an insulating material selected from a group consisting of glass fibers, polyolefin fibers, polyester fibers, polypropylene fibers, polyethylene fibers, polyethylene terephthalate fibers, polybutylene terephthalate fibers, cotton fibers, hemp fibers, jute fibers, kenaf fibers, rayon fibers, nylon fibers, acrylic fibers, copolyester fibers and mixtures thereof and (b) have an airflow resistivity of between about 3,000 to about 18,000 mks rayls/m.

17. The dishwasher of claim 1, further including an insulation blanket covering a top wall, a rear wall, a first side wall and a second side wall of said housing, said insulation blanket being constructed from a material selected from a group consisting of polyester, polyolefin, polyethylene, rayon, nylon, acrylic, hemp, kenaf, cotton, fiberglass and combinations thereof.

18. The dishwasher of claim 17, further including an insulating element provided in said access door of said housing.

19. The dishwasher of claim 4, wherein said first layer of fibrous insulating material and said barrier layer have a total thickness of between about 0.5 to about 4 inches.

20. The dishwasher of claim 4, wherein at least one shield of said first side shield, said second side shield and said third side shield includes a barrier layer.
